(19) United States
(12) Patent Application Publication
(10) Pub. No.: US 2017/0152909 A1
(43) Pub. Date: Jun. 1, 2017

(54) VIBRATION DAMPING APPARATUS

(71) Applicant: SUMITOMO RIKO COMPANY LIMITED, Komaki-shi (JP)

(72) Inventors: Noriaki YOSHII, Komaki-shi (JP); Akio SAIKI, Komaki-shi (JP); Kasumi FUJITA, Komaki-shi (JP); Keishi HATANAKA, Komaki-shi (JP)

(73) Assignee: SUMITOMO RIKO COMPANY LIMITED, Komaki-shi (JP)

(21) Appl. No.: 15/271,972

(22) Filed: Sep. 21, 2016

(30) Foreign Application Priority Data
Dec. 1, 2015 (JP) 2015-235224

(51) Int. Cl. F16F 3/087; B60K 5/12; F16F 1/38

(52) U.S. Cl. CPC F16F 3/0876; F16F 1/38; F16F 1/3842; B60K 5/1208

(57) ABSTRACT

A vibration damping apparatus including: a plurality of tubular vibration-damping devices each including an inner shaft member and an outer tube member connected by a connecting rubber elastic body; and an attachment member to which the tubular vibration-damping devices are separately attached on opposite sides thereof so as to be linked to each other so that at least one tubular vibration-damping device is arranged on each side of the attachment member. The tubular vibration-damping devices attached on the opposite sides of the attachment member are arranged so as to be remote from each other in an axial direction. Axial directions of the tubular vibration-damping devices attached on the opposite sides of the attachment member incline relative to each other.

### INCORPORATED BY REFERENCE

The disclosure of Japanese Patent Application No. 2015-235224 filed on Dec. 1, 2015 including the specification, drawings and abstract is incorporated herein by reference in its entirety.

### BACKGROUND OF THE INVENTION

1. Field of the Invention

The present invention relates to a vibration damping apparatus used for an automotive engine mount or the like.

2. Description of the Related Art

Conventionally, vibration damping apparatuses have been known as one type of vibration damping supports or vibration damping connectors disposed between components that make up a vibration transmission system in order to provide vibration damping linkage between the constituent components of the vibration transmission system, and are employed as an automotive engine mount or the like, for example. As disclosed in, for example, Japanese Unexamined Utility Model Publication No. JP-U-62-166347 or the like, the vibration damping apparatus has a structure in which an upper plate and a lower plate are elastically connected to each other by a pair of rubber members.

Meanwhile, the vibration damping apparatus is able to realize the desired vibration damping ability, supporting characteristics for the engine, or the like by appropriately setting the spring characteristics for input in each of the directions, namely the vertical direction, the lateral direction, and the front-rear direction. The spring characteristics of the vibration damping apparatus described in JP-U-62-166347 are set by the spring constant of the pair of the rubber members. Thus, hard spring characteristics are set in the direction in which the compression spring component of the rubber members predominates against the input, while soft spring characteristics are set in the direction in which the shear spring component of the rubber members predominates against the input.

However, with the vibration damping apparatus of construction shown in JP-U-62466347, it is difficult to set a hard spring against the input in the direction by which the rubber members undergo shear deformation. This causes difficulty in adjusting the spring characteristics in that direction with a large degree of freedom.

### SUMMARY OF THE INVENTION

It is therefore one object of this invention to provide a vibration damping apparatus of novel structure which is able to obtain a large degree of freedom in adjusting the spring characteristics in multiple directions.

The above and/or optional objects of this invention may be attained according to at least one of the following modes of the invention. The following modes and/or elements employed in each mode of the invention may be adopted at any possible optional combinations.

Specifically, a first mode of the present invention provides a vibration damping apparatus comprising: a plurality of tubular vibration-damping devices each including an inner shaft member and an outer tube member connected by a connecting rubber elastic body; and an attachment member to which the tubular vibration-damping devices are separately attached on opposite sides thereof so as to be linked to each other so that at least one tubular vibration-damping device is arranged on each side of the attachment member, wherein the tubular vibration-damping devices attached on the opposite sides of the attachment member are arranged so as to be remote from each other in an axial direction, and axial directions of the tubular vibration-damping devices attached on the opposite sides of the attachment member incline relative to each other.

The vibration damping apparatus of construction according to the first mode of the present invention makes it possible to adjust the spring characteristics in multiple directions with a large degree of freedom. That is, in each individual tubular vibration-damping device, high spring characteristics (hard spring characteristics) can be exhibited in the axis-perpendicular direction due to the compression spring component of the connecting rubber elastic body, while low spring characteristics (soft spring characteristics) can be exhibited in the axial direction due to the shear spring component of the connecting rubber elastic body. In this respect, the plurality of tubular vibration-damping devices are arranged so as to be remote from each other in the axial direction and their axial directions are inclined relative to each other. This makes it possible to eliminate the direction in which substantially only the shear spring component acts, thereby obtaining spring characteristics exhibited by combination of the compression spring component and the shear spring component in multiple directions.

Moreover, by adjusting relative incline angles of the tubular vibration-damping devices in the axial direction, it is also possible to adjust the ratio between the compression spring component and the shear spring component and to adjust the spring ratios for multiple directions. Also, by providing a bore having a shape of a recess or a through-hole to the connecting rubber elastic body so as to adjust the spring constant thereof as well, the spring ratio of the vibration damping apparatus can be adjusted.

A second mode of the present invention provides the vibration damping apparatus according to the first mode wherein the tubular vibration-damping devices attached on the opposite sides of the attachment member have identical structures with each other.

According to the second mode, the plurality of tubular vibration-damping devices arranged so as to be remote from each other in the axial direction will be made uniform, thereby achieving reduced cost or ease of manufacture.

A third mode of the present invention provides the vibration damping apparatus according to the first or second mode wherein the tubular vibration-damping devices attached to the opposite sides of the attachment member are symmetrically arranged.

According to the third mode, since the tubular vibration-damping devices are symmetrically arranged, the spring characteristics of the tubular vibration-damping devices disposed on the opposite sides are made symmetrical. Thus, in the case of supporting a vibration damping support target such as a power unit, for example, the vibration damping apparatus is able to stably support the target. Besides, by making the spring characteristics of the plurality of tubular vibration-damping devices symmetrical, it will be easy to tune the spring characteristics for each direction.

A fourth mode of the present invention provides the vibration damping apparatus according to any one of the first through third modes wherein on at least one side of the attachment member, the at least one tubular vibration-damping device comprises a plurality of tubular vibration-damping devices that are arranged and attached in parallel.

According to the fourth mode, the plurality of tubular vibration-damping devices arranged in parallel make it possible to adjust the spring characteristics with a larger degree of freedom.

A fifth mode of the present invention provides the vibration damping apparatus according to the fourth mode wherein the tubular vibration-damping devices arranged in parallel on a same side of the attachment member are constituted by components identical with each other.

According to the fifth mode, the constituent components of the plurality of tubular vibration-damping devices arranged in parallel will be made uniform, thereby achieving reduced cost or ease of manufacture.

A sixth mode of the present invention provides the vibration damping apparatus according to the fourth or fifth mode wherein the tubular vibration-damping devices arranged in parallel on a same side of the attachment member have spring characteristics different from each other.

According to the sixth mode, a combined spring of the plurality of tubular vibration-damping devices having spring characteristics different from each other makes it possible to adjust and set the spring characteristics with a larger degree of freedom.

A seventh mode of the present invention provides the vibration damping apparatus according to any one of the fourth through sixth modes wherein the tubular vibration-damping devices arranged in parallel on a same side of the attachment member are constituted by components identical with each other, the tubular vibration-damping devices have different springs on respective circumferences, and the tubular vibration-damping devices arranged in parallel are attached to the attachment member in circumferential orientations different from each other.

According to the seventh mode, the tubular vibration-damping devices having different springs on the respective circumferences are attached in parallel on the same side of the attachment member in the circumferential orientations different from each other. Thus, a combined spring of the plurality of tubular vibration-damping devices having structures identical with each other makes it possible to adjust and set the spring characteristics with a large degree of freedom.

An eighth mode of the present invention provides the vibration damping apparatus according to any one of the fourth through seventh modes wherein a combined spring of the tubular vibration-damping devices arranged in parallel on one side of the attachment member and that on another side of the attachment member are equal to each other.

According to the eighth mode, even with the structure in which the plurality of tubular vibration-damping devices are arranged in parallel on each of the opposite sides of the attachment member, it is possible to obtain the springs on the opposite sides of the attachment member in a good balance. Therefore, the device is able to stably support a vibration damping support target such as a power unit, for example.

A ninth mode of the present invention provides the vibration damping apparatus according to any one of the fourth through eighth modes wherein the tubular vibration-damping devices arranged in parallel on a same side of the attachment member further include respective axis-perpendicular stoppers each limiting an elastic deformation volume of the corresponding connecting rubber elastic body in an axis-perpendicular direction, and in the tubular vibration-damping devices, the axis-perpendicular stoppers each limit the elastic deformation volume of the corresponding connecting rubber elastic body in the axis-perpendicular direction different from each other.

According to the ninth mode, owing to the axis-perpendicular stoppers of the tubular vibration-damping devices arranged in parallel, it is possible to limit the elastic deformation volumes of the connecting rubber elastic bodies of the tubular vibration-damping devices in multiple directions, thereby improving durability of the connecting rubber elastic body. Moreover, the plurality of tubular vibration-damping devices are provided with the respective axis-perpendicular stoppers for the different directions from each other. By so doing, in comparison with the case where the axis-perpendicular stoppers for multiple directions are provided to a single tubular vibration-damping device, the structure of each tubular vibration-damping device will be simplified.

A tenth mode of the present invention provides the vibration damping apparatus according to any one of the first through ninth modes wherein the inner shaft member and the outer tube member are bonded to the connecting rubber elastic body.

According to the tenth mode, the connecting rubber elastic body will be prevented from sliding with respect to the inner shaft member and the outer tube member. Thus, a desired spring will be stably obtained, while avoiding occurrence of sound or damage to the connecting rubber elastic body due to friction.

According to the present invention, the plurality of tubular vibration-damping devices are arranged so as to be remote from each other in the axial direction, and the axial directions of the tubular vibration-damping devices incline relative to each other. This makes it possible to eliminate the direction in which only the shear spring component acts, and to obtain the spring characteristics, for which the compression spring component and the shear spring component are combined, in multiple directions. Moreover, by adjusting relative incline angles of the tubular vibration-damping devices in the axial direction, it is also possible to adjust the ratio between the compression spring component and the shear spring component and to appropriately set the spring ratios for multiple directions.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a perspective view showing a vibration damping apparatus in the form of an engine mount according to a first embodiment of the present invention, with inner brackets mounted thereon;

FIG. 2 is a front view of the engine mount shown in FIG. 1;

FIG. 3 is a top plane view of the engine mount shown in FIG. 1;

FIG. 4 is a right side view of the engine mount shown in FIG. 1;

FIG. 5 is a cross sectional view taken along line 5-5 of FIG. 4;

FIG. 6 is a cross sectional view taken along line 6-6 of FIG. 4; and

FIG. 7 is a view of the engine mount shown in FIG. 1 with no inner bracket mounted thereon, which corresponds to a view as seen in a direction indicated by arrow 7 of FIG. 5.

### DETAILED DESCRIPTION OF PREFERRED EMBODIMENTS

An embodiment of the present invention will be described below in reference to the drawings.

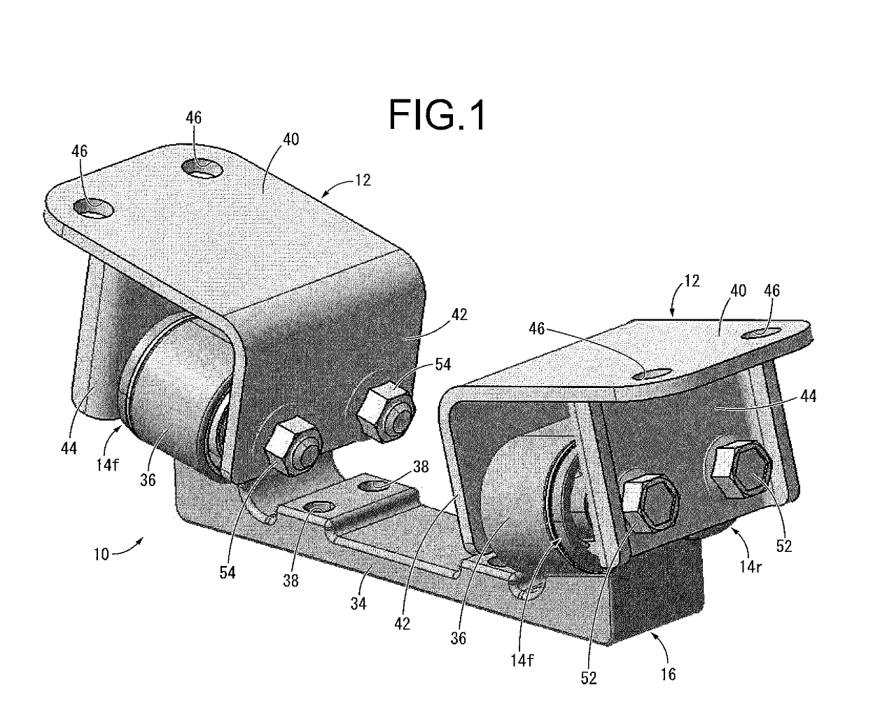

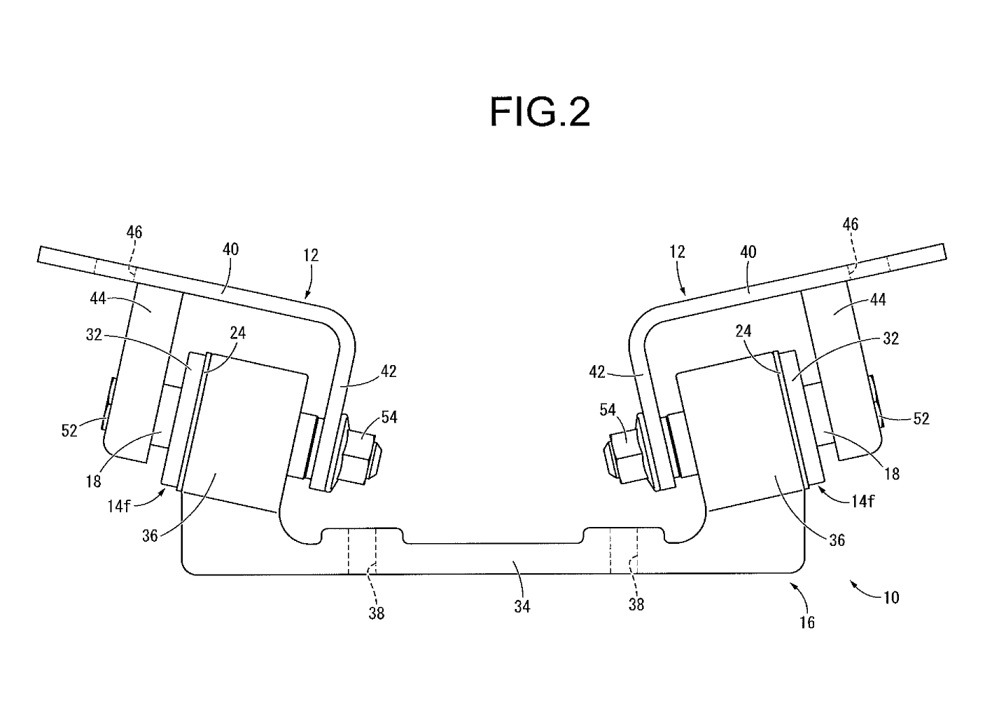

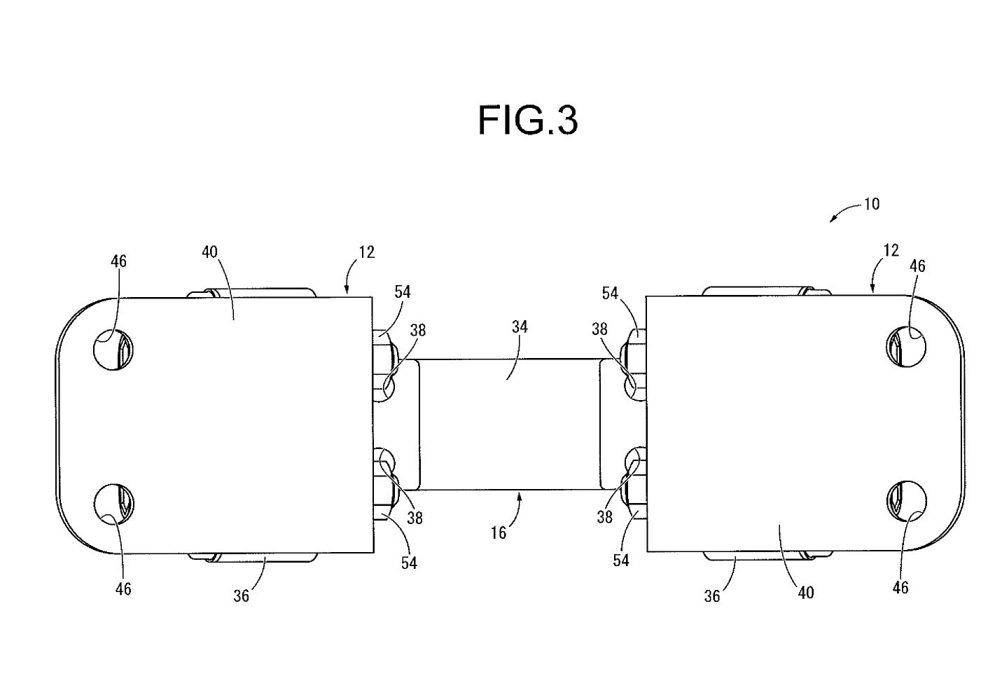

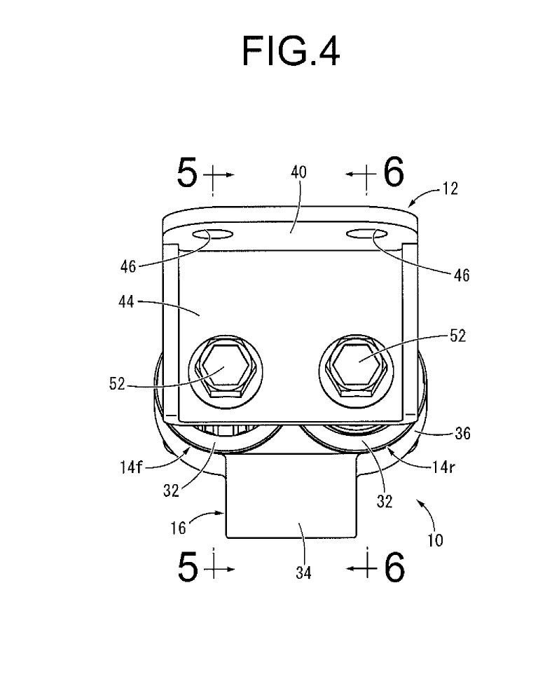

FIGS. 1 through 4 depict an automotive engine mount 10 as a first embodiment of the vibration damping apparatus constructed according to the present invention, with inner brackets 12, 12 mounted thereon. The engine mount 10 has a structure in which bushings 14 serving as tubular vibration-damping devices are separately attached to the left-right opposite ends of an attachment member 16 so that two bushings 14 are arranged on each end thereof. Accordingly, the bushings 14, 14, 14, 14 are linked to each other by the attachment member 16. In the description hereinbelow, as a general rule, the vertical direction refers to the vertical direction in FIG. 2, the lateral direction refers to the lateral direction in FIG. 2, and the front-rear direction refers to the lateral direction in FIG. 4.

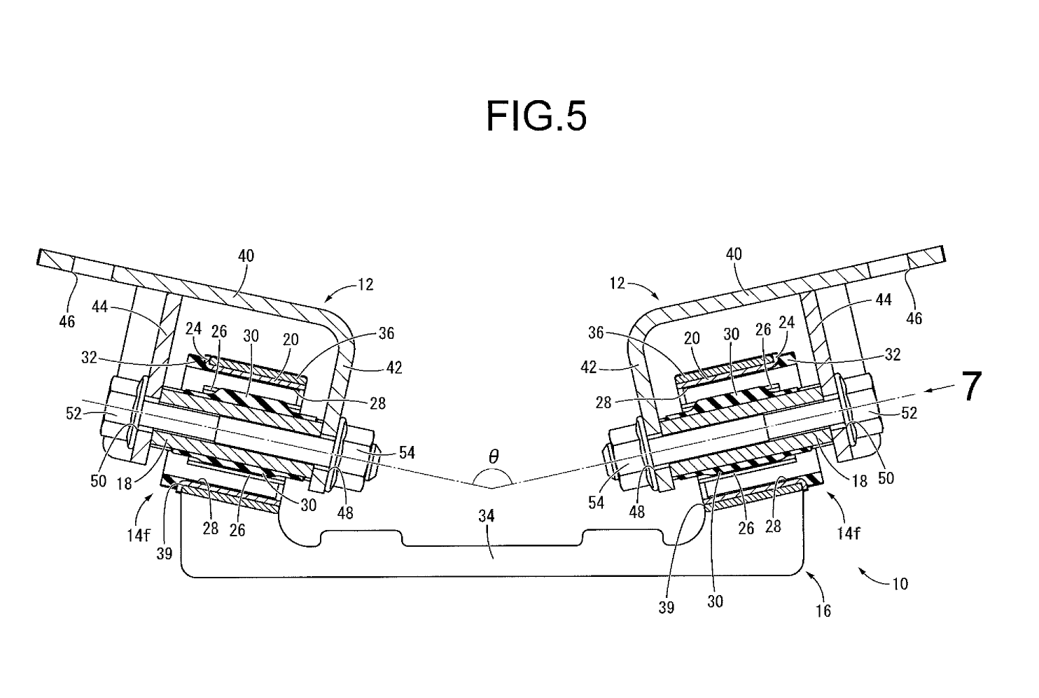

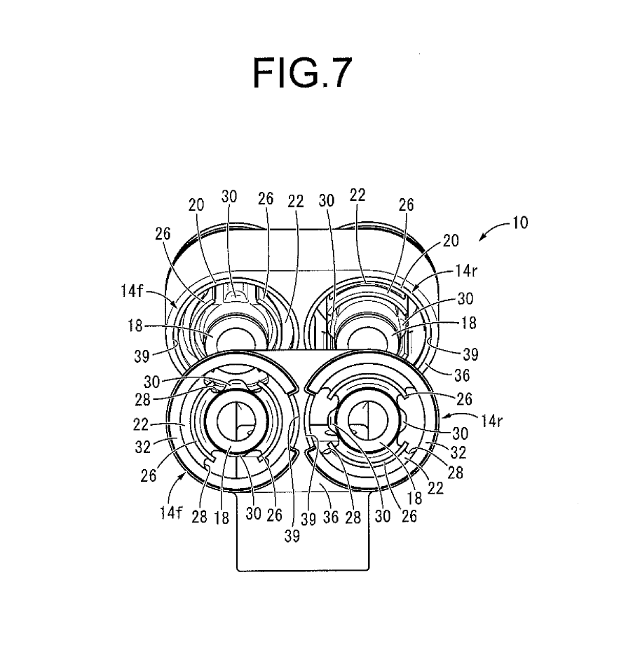

Described more specifically, the bushings 14 each have a structure in which an inner shaft member 18 and an outer tube member 20 are elastically connected to each other by a connecting rubber elastic body 22. The inner shaft member 18 is a rigid member made of metal or synthetic resin, and as shown in FIGS. 5 through 7, has a small-diameter, generally round tubular shape. The outer tube member 20 is a rigid member made of metal or synthetic resin like the inner shaft member 18, and has a thin-walled, large-diameter, generally round tubular shape. A stopper part 24 is integrally formed with one axial end of the outer tube member 20 so as to flare radially outward. In the present embodiment, the stopper part 24 has a roughly C-ring plate shape and extends in the circumferential direction continuously for a length less than once around the circumference. Besides, in the attached state to the attachment member 16 described later, the two bushings 14f, 14f located in the front are arranged such that a gap between the two ends of the stopper part 24 is positioned in the diametrical direction of opposition of intermediate members 26, 26 (described later), while the two bushings 14r, 14r located in the rear are arranged such that a gap between the two ends of the stopper part 24 is positioned in the diametrical direction of opposition of bores 28, 28 (described later). Note that since the bushings 14f, 14f in the front and the bushings 14r, 14r in the rear have the identical structures with each other except the position of the circumferential ends of the stopper part 24, they are identified as the bushing 14 unless necessary in particular.

The inner shaft member 18 is inserted into the outer tube member 20, and the connecting rubber elastic body 22 is disposed radially between the inner shaft member 18 and the outer tube member 20. The connecting rubber elastic body 22 is formed of rubber or elastomer having elasticity like rubber, and has a thick-walled, generally round tubular shape. The inner circumferential surface of the connecting rubber elastic body 22 is bonded to the outer circumferential surface of the inner shaft member 18, while the outer circumferential surface of the connecting rubber elastic body 22 is bonded to the inner circumferential surface of the outer tube member 20. The connecting rubber elastic body 22 may be bonded by adhesive to the inner shaft member 18 and the outer tube member 20 during or after formation, or alternatively may be bonded by vulcanization thereto during formation.

Besides, a pair of intermediate members 26, 26 are bonded to the connecting rubber elastic body 22. The intermediate member 26 is a rigid member formed of metal, synthetic resin or the like, and has a plate shape that curves roughly arcuately in the thickness direction. The intermediate members 26, 26 are disposed between the opposed faces of the inner shaft member 18 and the outer tube member 20 in the axis-perpendicular direction, and are bonded to the radially middle portion of the connecting rubber elastic body 22. Each of the intermediate members 26, 26 extends in the circumferential direction for a length less than half the circumference, and the intermediate members 26, 26 are disposed in opposition along an axis in the diametrical direction while the two circumferential ends of one intermediate member 26 are remote from the two circumferential ends of the other intermediate member 26 in the circumferential direction. Note that the intermediate members 26, 26 are bonded by vulcanization to the connecting rubber elastic body 22 so as to be partially embedded therein by, for example, being set in the mold during molding of the connecting rubber elastic body 22.

Additionally, a pair of bores 28, 28 are provided to the connecting rubber elastic body 22. The bores 28, 28 are holes that perforate the connecting rubber elastic body 22 in the axial direction, and are provided on the opposite sides of the inner shaft member 18 along an axis in the diametrical direction of the connecting rubber elastic body 22. In this way, by providing the bores 28, 28 partially along the circumference of the connecting rubber elastic body 22 at the locations that are in opposition along an axis in the diametrical direction thereof, the spring of the bushing 14 in the diametrical direction (the diametrical spring constant of the connecting rubber elastic body 22) varies along the circumference. In particular, the spring in the direction of opposition of the bores 28, 28 and the spring in the direction orthogonal thereto are different from each other, so that the spring in the direction of opposition of the bores 28, 28 is made small. Note that the direction of opposition of the bores 28, 28 is the diametrical direction of the bushing that is roughly orthogonal to the direction of opposition of the intermediate members 26, 26, and the two circumferential ends of the intermediate members 26, 26 project into the corresponding one of the bores 28, 28. It should be appreciated that in the bushing 14, soft spring characteristics due to the shear spring component of the connecting rubber elastic body 22 are set in the diametrical direction along which the bores 28, 28 are provided, while hard spring characteristics due to the compression spring component of the connecting rubber elastic body 22 are set in the diametrical direction along which the intermediate members 26, 26 are in opposition.

Moreover, each bore 28 extends in the circumferential direction, and an axis-perpendicular stopper rubber 30 is formed at the circumferentially center portion thereof so as to project radially from the inner shaft member 18 side toward the outer tube member 20. Accordingly, the bushing 14 includes an axis-perpendicular stopper for limiting the elastic deformation volume of the connecting rubber elastic body 22 by means of abutment between the inner shaft member 18 and the outer tube member 20 via the axis-perpendicular stopper rubbers 30, 30. In the present embodiment, each axis-perpendicular stopper rubber 30 is integrally formed with the connecting rubber elastic body 22, and the axis-perpendicular stopper rubber 30 formed in one bore 28 and the axis-perpendicular stopper rubber 30 formed in the other bore 28 have the projecting dimensions different from each other.

Furthermore, with the connecting rubber elastic body 22, an axial-direction stopper rubber 32 is integrally formed. The axial-direction stopper rubber 32 is bonded to the stopper part 24 of the outer tube member 20, and projects axially outward from the stopper part 24.

Meanwhile, the attachment member 16 includes a linking part 34 of generally plate shape and bushing mounting parts 36 provided at the left-right opposite ends of the linking part 34 so as to be attached to the bushings 14.

The linking part 34 is a high rigidity component made of metal or synthetic resin, and the left-right middle portion thereof has a plate shape that extends in the direction roughly orthogonal to the vertical direction, while the left-right opposite end portions thereof extend upward. Moreover, with the linking part 34, at each of the two locations that are laterally remote from each other, two body fastening holes 38 are provided in the front and rear so as to vertically perforate the linking part 34. In the present embodiment, the linking part 34 is partially made thick at the left and right two locations where the body fastening holes 38 are formed. This will prevent increase in weight or the like because of the linking part 34 being unnecessarily thick-walled, while sufficiently obtaining the hole length of the body fastening holes 38.

The bushing mounting part 36 extends generally laterally with an elliptical cross section, and includes two mounting holes 39 perforating the bushing mounting part 36 in the lengthwise direction (generally in the lateral direction) while being arranged in parallel in the front and rear. The mounting hole 39 has a diameter slightly smaller than the outside diameter of the outer tube member 20 so as to allow the outer tube member 20 to be secured press-fit thereinto. The bushing mounting parts 36 are separately provided to the left-right opposite ends of the linking part 34. Whereas the bushing mounting parts 36 may be formed separately from the linking part 34 so as to be fixed thereto later by means of welding or the like, in the present embodiment, the two bushing mounting parts 36, 36 are both integrally formed with the linking part 34 by casting or die casting.

To the attachment member 16 of this construction, the bushings 14 are attached. Specifically, by the outer tube member 20 of each bushing 14 being secured press-fit into the corresponding mounting hole 39 of the bushing mounting parts 36 of the attachment member 16, the bushings 14 are attached to each bushing mounting part 36 of the attachment member 16. In the present embodiment, the stopper part 24 of the outer tube member 20 is in contact with the rim face of the mounting hole 39 of the bushing mounting part 36, so that the outer tube member 20 is positioned relative to the bushing mounting part 36 in the axial direction. Besides, on each of the left and right sides of the attachment member 16, two mounting holes 39, 39 are arranged in parallel in the front and rear, so that the bushings 14f, 14r respectively attached to the two mounting holes 39, 39 are arranged in parallel to each other. That is, in the present embodiment, on each of the left-right opposite sides of the attachment member 16, two bushings 14f, 14r are arranged in parallel in the front and rear and both are attached to the attachment member 16.

In addition, since the bushing mounting parts 36 including the mounting holes 39, 39 are separately provided on the left-right opposite ends of the attachment member 16, the bushings 14f, 14r attached to the left-side bushing mounting part 36 and the bushings 14f, 14r attached to the right-side bushing mounting part 36 are arranged so as to be remote from each other in the axial direction of the bushings 14.

Moreover, in the present embodiment, the two bushings 14f, 14f that are remote from each other in the axial direction and each disposed in the front side have roughly identical structures with each other so as to be made uniform, while the bushings 14r, 14r that are disposed in the rear side have roughly identical structures with each other so as to be made uniform. Note that in the present embodiment, the bushings 14f, 14r that are arranged in parallel in the front and rear in the attached state to the attachment member 16 have structures different from each other with the stopper part 24 and the axial-direction stopper rubber 32 so that the stopper part 24 and the axial-direction stopper rubber 32 of one bushing 14f (14r) will not interfere with those of the other bushing 14r (14f). However, the bushings 14f, 14r are formed by vulcanization molding of the connecting rubber elastic body 22 with the common outer tube members 20 set in the mold in the different circumferential orientations during molding of the connecting rubber elastic body 22. Therefore, with the bushings 14f, 14r, the constituent components including the outer tube member 20 are identical with each other, thereby achieving reduced cost or the like through uniformization of the components. Furthermore, since the bushings 14f, 14r have identical spring characteristics and vibration damping abilities with each other, it is possible to uniformize the ability evaluation during the design or the like, thereby facilitating manufacture. Also, in the case where the interference of the stopper part 24 and the axial-direction stopper rubber 32 is insignificant, namely, if the bushings 14f, 14r are arranged in the front and rear so as to be sufficiently remote from each other or the like, it would also be acceptable to form the stopper part 24 and the axial-direction stopper rubber 32 annularly about the entire circumference so that the front and rear bushings 14f, 14r have identical structures.

Furthermore, the bushings 14f, 14r arranged in parallel in the front and rear are attached to the attachment member 16 with their orientations set such that the bores 28, 28 of one bushing 14f (14r) are positioned in the circumferential orientation different from those of the other bushing 14r (14f). By so doing, in the attached state to the attachment member 16, the bushing 14f in the front and the bushing 14r in the rear have different springs from each other for the same orientation. In the present embodiment, the bores 28, 28 of the front bushing 14f are positioned in the vertical direction, while the bores 28, 28 of the rear bushing 14r are positioned in the front-rear direction, so that the front bushing 14f and the rear bushing 14r are attached to the attachment member 16 in the orientation different by 90° in the circumferential direction. Therefore, a hard spring of the rear bushing 14r will be exerted on the input in the vertical direction, while a soft spring of the front bushing 14f will be exerted on the input in the front-rear direction.

In addition, with the bushings 14f, 14r arranged in parallel in the front and rear, since the orientations in which the bores 28, 28 are positioned are different from each other, the directions of projection of the axis-perpendicular stopper rubbers 30, 30 projecting into the bores 28, 28 are also different from each other. Thus, the direction in which the axis-perpendicular stopper of the bushing 14f limits elastic deformation of the connecting rubber elastic body 22 and the direction in which the axis-perpendicular stopper of the bushing 14r limits elastic deformation of the connecting rubber elastic body 22 are different from each other. In this way, the bushings 14f, 14r attached to the attachment member 16 in the different orientations each have the axis-perpendicular stopper in the individual axis in the diametrical direction, so that the engine mount 10 is provided with the stoppers in the two directions.

Besides, in the present embodiment, the engine mount 10 is symmetrical with respect to a plane of symmetry that extends in the vertical and front-rear directions at the lateral center, and the bushings 14f, 14r on the left and the bushings 14f, 14r on the right are symmetrically arranged. Moreover, since the bushings 14f, 14r attached on the left side of the attachment member 16 are identical with the respective bushings 14f, 14r attached on the right side thereof. Thus, the combined spring of the bushings 14f, 14r attached on the left side of the attachment member 16 and the combined spring of the bushings 14f, 14r attached on the right side of the attachment member 16 are equal to each other.

Here, the center axes of the mounting holes 39, 39 of the bushing mounting part 36 provided on the left side of the attachment member 16 incline relative to the center axes of the mounting holes 39, 39 of the bushing mounting part 36 provided on the right side of the attachment member 16. In the present embodiment, the center axes of the mounting holes 39, 39 of each bushing mounting part 36 both incline vertically with respect to the lateral direction, and incline upward going laterally outward.

By so doing, since the bushing 14 is mounted onto the mounting hole 39 of the bushing mounting part 36, as indicated by the dot-and-dash line in FIGS. 4 and 5, the center axes of the bushings 14f, 14r mounted onto the left bushing mounting part 36 incline relative to the center axes of the bushings 14f, 14r mounted onto the right bushing mounting part 36. In other words, the angle θ created by the center axes of the left bushings 14f, 14r and the center axes of the right bushings 14f, 14r is not equal to 180° (θ≠180°).

In the present embodiment, the left bushings 14f, 14r and the right bushings 14f, 14r are arranged symmetrically in the lateral direction, and the incline angles of the center axes of the bushings 14f, 14r with respect to the lateral direction are equal to each other.

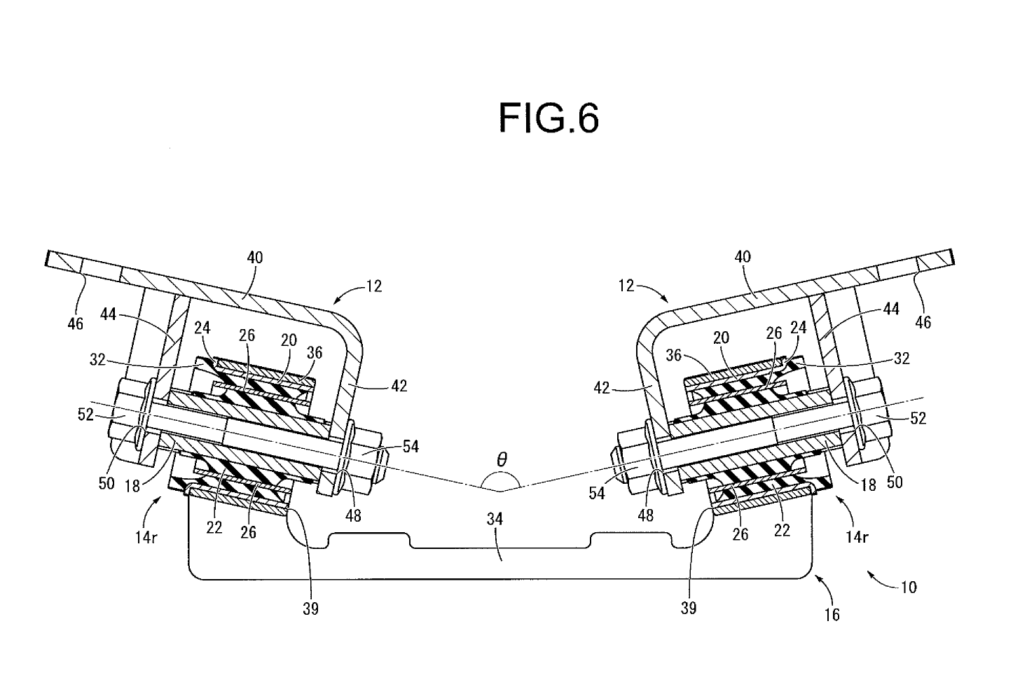

Moreover, the center axes of the left bushings 14f, 14r are parallel to each other so as to be arranged in parallel with the same incline angle with respect to the lateral direction. Similarly, the center axes of the right bushings 14f, 14r are also parallel to each other so as to be arranged in parallel with the same incline angle with respect to the lateral direction. Therefore, the relative incline angle of the center axes of the left and right bushings 14f, 14f in the front as shown in FIG. 5 and the relative incline angle of the center axes of the left and right bushings 14f, 14f in the rear as shown in FIG. 6 are equal to each other.

The specific angle θ is not limited in any particular way as long as the angle is not 180°, but may be appropriately set depending on the required spring characteristics or the like. In preferred practice, the angle θ is set in the range of 60°≦θ≦160°.

Furthermore, the inner brackets 12 are mounted onto the bushings 14f, 14r arranged in parallel on the respective left and right ends of the attachment member 16. The inner brackets 12 are high rigidity components like the attachment member 16, and each include an upper wall 40 that extends above the bushings 14f, 14r and the bushing mounting part 36 of the attachment member 16, an inside wall 42 projecting downward from the laterally inner end of the upper wall 40, and an outside wall 44 positioned in opposition to the inside wall 42 on the laterally outer side.

The upper wall 40 of the inner bracket 12 has a generally flat plate shape and the laterally outer edge portion thereof are perforated in the thickness direction by two power-unit fastening holes 46 provided in the front and rear. Besides, the inside wall 42 is integrally formed with the laterally inner end of the upper wall 40 and extends roughly orthogonally to the upper wall 40. The lower portion of the inside wall 42, which is the projecting distal end from the upper wall 40, is perforated in the thickness direction by two inner fastening holes 48 provided in the front and rear. Moreover, the outside wall 44 is fixed to the upper wall 40 so as to be positioned in opposition to the inside wall 42 on the laterally outer side. The outside wall 44 extends roughly orthogonally to the upper wall 40 while extending roughly in parallel to the inside wall 42. The upper end of the outside wall 44 is fixed to the upper wall 40 and the lower portion thereof, which is the projecting distal end from the upper wall 40, is perforated in the thickness direction by two inner fastening holes 50 provided in the front and rear. In the present embodiment, the front-rear opposite ends of the outside wall 44 are provided with respective reinforcing ribs projecting laterally outward.

The inner brackets 12 of this construction are fixed by fastening bolts 52 and nuts 54 to the inner shaft members 18, 18 of the bushings 14f, 14r arranged in parallel on the respective left and right sides. Specifically, the each inner bracket 12 is disposed such that the upper wall 40 is placed above the bushings 14f, 14r arranged in parallel, while the inside wall 42 and the outside wall 44 clasp the inner shaft members 18, 18 of the bushings 14f, 14r in the axial direction. By the fastening bolt 52 being inserted into the inner hole of each inner shaft member 18 as well as the corresponding inner fastening holes 48, 50 of the inside and outside walls 42, 44, and then the nut 54 being threaded onto the shaft of the inserted fastening bolt 52, the each inner bracket 12 is fixed to the inner shaft members 18, 18 of the bushings 14f, 14r arranged in parallel. Note that the distal end of the shaft of the fastening bolt 52 is secured by swaging to the nut 54, thereby preventing looseness of the nut 54.

In the present embodiment, the inner brackets 12 independent of each other are separately mounted onto the bushings 14f, 14r arranged in parallel on the left end of the attachment member 16 as well as onto the bushings 14f, 14r arranged in parallel on the right end of the attachment member 16. The left and right inner brackets 12, 12 have identical structures with each other and are arranged symmetrically in the lateral direction, so as to be separately mounted onto the bushings 14f, 14r on the left side and onto the bushings 14f, 14r on the right side.

Also, the outside wall 44 of the inner bracket 12 is in opposition to the stopper parts 24, 24 of the bushings 14f, 14r. Accordingly, by means of abutment between the outside wall 44 and the stopper parts 24, 24 via the axial-direction stopper rubbers 32, 32, an axial stopper for limiting elastic deformation volume of the connecting rubber elastic bodies 22, 22 is provided. In the engine mount 10 of the present embodiment, the axis-perpendicular stopper and the axial stopper of the bushings 14f, 14r provide the stoppers for three directions, namely, the vertical, front-rear, and lateral directions.

The engine mount 10 to which the inner brackets 12, 12 are mounted in this way is configured to be attached to a power unit and a vehicle body (not shown). Specifically, each inner bracket 12, which is mounted onto the inner shaft member 18 of the bushing 14, is arranged such that the upper wall 40 is fixed to the power unit by bolts (not shown) being inserted into the power-unit fastening holes 46, 46. Meanwhile, the attachment member 16, which is attached to the outer tube members 20 of the bushings 14, is arranged such that the linking part 34 is fixed to the vehicle body by bolts (not shown) being inserted into the corresponding body fastening holes 38. By so doing, the engine mount 10 is interposed between the power unit and the vehicle body so that the power unit is supported in a vibration-damping manner on the vehicle body via the engine mount 10.

With the engine mount 10 mounted onto the vehicle, when vibrations to be damped such as an engine shake, an idling vibration, a driving rumble or the like are input, the four bushings 14, 14, 14, 14 will exhibit a vibration damping effect.

Here, in each of the vertical, front-rear, and lateral directions, which are the main vibration input directions, the engine mount 10 is able to obtain a hard spring owing to the compression spring component of the connecting rubber elastic body 22. This makes it possible to tune the spring characteristics with a large degree of freedom.

Specifically, the bushings 14f, 14r on the left side and the bushings 14f, 14r on the right side that provide the spring of the engine mount 10 have the center axes inclining relative to each other. Therefore, the input never coincides with all of the axial directions of the four bushings 14, 14, 14, 14, so that with regard to the bushings 14f, 14r on the left side and the bushings 14f, 14r on the right side, the compression spring component of the connecting rubber elastic body 22 can be obtained at least one side thereof. Therefore, relatively hard spring characteristics are readily set with respect to the inputs in the multiple directions, thereby tuning spring characteristics with a large degree of freedom in the multiple directions. Thus, the vibration damping ability or supporting characteristics required in each direction will be advantageously met.

In the present embodiment, the center axes of the bushings 14f, 14r on the left side incline with respect to all of the three directions, namely, the vertical, front-rear, and lateral directions, so that a relatively hard spring will be obtained owing to the compression spring component with respect to each direction of the vertical, front-rear, and lateral directions which are the main vibration input directions. Similarly, the center axes of the bushings 14f, 14r on the right side also incline with respect to all of the three directions, namely, the vertical, front-rear, and lateral directions, so that a relatively hard spring will be obtained owing to the compression spring component with respect to each direction of the vertical, front-rear, and lateral directions which are the main vibration input directions.

In the present embodiment, with regard to the bushings 14f, 14r on the left side and the bushings 14f, 14r on the right side, the center axes extend in the lateral direction while inclining in the vertical direction. Accordingly, as the incline angle ((180°−θ)/2) of the center axis of the bushing with respect to the lateral direction becomes larger, the spring characteristics in the lateral direction becomes harder as well as the spring characteristics in the vertical direction becomes softer. This is because as the incline angle of the center axis of the bushing with respect to the lateral direction becomes larger, the ratio of the compression spring component in the spring in the lateral direction becomes larger as well as the ratio of the shear spring component in the spring in the vertical direction becomes larger. As will be appreciated from the above, by adjusting the incline angle of the center axis of the bushing with respect to the lateral direction, the springs of the engine mount 10 in the vertical and lateral directions can be adjusted. In preferred practice, by setting the incline angle of the center axis of the bushing with respect to the lateral direction in the range of 60°≦θ≦160°, it is possible to set the spring in the vertical direction and the spring in the lateral direction with a practical spring ratio.

Additionally, the springs in the vertical and lateral directions can be adjusted by the bores 28, 28 or the intermediate members 26, 26 of each bushing 14. That is, by adjusting the springs of the four bushings 14, 14, 14, 14, it is possible to adjust the spring of the engine mount 10 constituted by those four bushings 14, 14, 14, 14.

Besides, on each of the left-right opposite sides, two bushings 14f, 14r are arranged in parallel in the front and rear, and the two bushings 14f, 14r arranged in parallel have roughly identical structures with each other while being attached to the attachment member 16 so as to be oriented in the circumferential directions different from each other. The bushing 14 is disposed such that the bores 28, 28 are provided along an axis in the diametrical direction, while the intermediate members 26, 26 are positioned in opposition along another axis in the diametrical direction. Thus, the spring is not constant but varied along the circumference (in the circumferential direction). By so doing, the bushings 14f, 14r arranged in parallel have spring characteristics different from each other in the diametrical directions that correspond to the vertical and front-rear directions. This makes it easy to adjust the combined spring component in the vertical and front-rear directions of the bushings 14f, 14r arranged in parallel with a large degree of freedom.

Moreover, in the present embodiment, the bushings 14f, 14r arranged in parallel are disposed in the circumferential orientations different by 90° from each other. Thus, with regard to the bushings 14f, 14r, the direction of arrangement of the pair of bores 28, 28 of one bushing 14f (14r) coincides with the vertical direction, while that of the other bushing 14r (14f) coincides with the front-rear direction. Accordingly, in either one bushing 14f (14r), the compression spring component predominates with respect to the inputs in the vertical and front-rear directions, thereby obtaining hard spring characteristics.

Furthermore, since the bushings 14f, 14r arranged in parallel are disposed in the circumferential orientations different from each other, the directions of projection of the axis-perpendicular stopper rubbers 30, 30 of the bushings 14f, 14r are different from each other, so that the axis-perpendicular stopper actions of the bushings 14f, 14r will exhibit in the different directions from each other. Therefore, through a simple structure of only providing the axis-perpendicular stopper rubbers 30, 30 on the opposite sides in the diametrical direction of each bushing 14, stopper action can be obtained in more directions.

An embodiment of the present invention has been described in detail above, but the present invention is not limited to those specific descriptions. For example, the arrangement of the tubular vibration-damping devices that are remote from each other in the axial direction is not limited to the mode illustrated in the preceding embodiment wherein two of them are arranged in parallel on each side. It would also be acceptable that a single tubular vibration-damping device is arranged on each side, or alternatively, three or more of them are arranged in parallel on each side. Moreover, the number of the tubular vibration-damping device disposed on one side so as to be remote from each other in the axial direction may be different from the number of the tubular vibration-damping devices disposed on the other side.

In addition, in the case where a plurality of tubular vibration-damping devices are arranged in parallel on the same side, the center axes of the tubular vibration-damping devices arranged in parallel may extend roughly parallel to each other as shown in the preceding embodiment, or alternatively may extend nonparallel to each other. Specifically, for example, by the tubular vibration-damping devices arranged in parallel being provided such that their center axes extend nonparallel so as to incline in the vertical direction with the incline angles different from each other, different spring characteristics can be set to those tubular vibration-damping devices. Furthermore, by the tubular vibration-damping devices arranged in parallel being provided such that their center axes extend nonparallel so as to incline in the front-rear direction with the incline angles different from each other, a large spring constant can be set in the lateral direction without changing the spring constant in the vertical direction, or the like. In particular, if the tubular vibration-damping devices relatively inclining in the front-rear direction are symmetrically arranged in parallel in the front-rear direction, it is possible to set such that the component forces generated by the tubular vibration-damping devices arranged in parallel during input in the lateral direction will cancel each other.

Also, whereas in the preceding embodiment, a plurality of tubular vibration-damping devices have identical structures, the plurality of tubular vibration-damping devices may have different structures from each other. For example, it would also be possible to make it different from each other whether the bore 28 or the intermediate member 26 is existent or not, and make the spring characteristics different from each other. Moreover, in the preceding embodiment, a solid-type bushing 14 is disclosed as one example of the tubular vibration-damping device. However, a bushing of fluid-filled type that utilizes vibration damping effect based on flow action of the fluid or liquid sealed inside may be employed as the tubular vibration-damping device.

Besides, with regard to the tubular vibration-damping devices arranged so as to be remote from each other in the axial direction, as long as their center axial directions incline with respect to each other, the center axial direction of the tubular vibration-damping on either one side may be non-inclined with respect to the lateral direction, for example. Moreover, with regard to the tubular vibration-damping devices arranged so as to be remote from each other in the axial direction, their incline angles can be set such that the angle θ created by the respective center axes is greater than 180°.

Furthermore, whereas in preferred practice, the tubular vibration-damping devices arranged so as to be remote from each other in the axial direction are symmetrically arranged as shown in the preceding embodiment, they may be arranged in an asymmetrical manner.

Additionally, the structure of the attachment member should not be construed as limited to the specific structure taught in the preceding embodiment. For example, the fixing structure to the vehicle body (the body fastening holes 38) is not essential to the attachment member but can be provided to any component other than the attachment member. Moreover, the attachment member is configured to be fixed to either the inner shaft member or the outer tube member of the tubular vibration-damping device. Thus, it would also be acceptable that for at least one of the plurality of tubular vibration-damping devices, the attachment member is to be fixed to the inner shaft member, while for another tubular vibration-damping device, the attachment member is to be fixed to the outer tube member.

The application range of the present invention is not limited to automotive vibration damping apparatuses illustrated in the preceding embodiment, but the present invention is preferably applicable to vibration damping apparatuses used for motorized two wheeled vehicles, rail vehicles, industrial vehicles, or the like. Moreover, the vibration damping apparatus according to the present invention is also applicable to sub-frame mounts, differential mounts, or the like besides engine mounts.

What is claimed is:

1. A vibration damping apparatus comprising:
a plurality of tubular vibration-damping devices each including an inner shaft member and an outer tube member connected by a connecting rubber elastic body; and
an attachment member to which the tubular vibration-damping devices are separately attached on opposite sides thereof so as to be linked to each other so that at least one tubular vibration-damping device is arranged on each side of the attachment member, wherein
the tubular vibration-damping devices attached on the opposite sides of the attachment member are arranged so as to be remote from each other in an axial direction, and
axial directions of the tubular vibration-damping devices attached on the opposite sides of the attachment member incline relative to each other.

2. The vibration damping apparatus according to claim 1, wherein the tubular vibration-damping devices attached on the opposite sides of the attachment member have identical structures with each other.

3. The vibration damping apparatus according to claim 1, wherein the tubular vibration-damping devices attached to the opposite sides of the attachment member are symmetrically arranged.

4. The vibration damping apparatus according to claim 1, wherein on at least one side of the attachment member, the at least one tubular vibration-damping device comprises a plurality of tubular vibration-damping devices that are arranged and attached in parallel.

5. The vibration damping apparatus according to claim 4, wherein the tubular vibration-damping devices arranged in parallel on a same side of the attachment member are constituted by components identical with each other.

6. The vibration damping apparatus according to claim 4, wherein the tubular vibration-damping devices arranged in parallel on a same side of the attachment member have spring characteristics different from each other.

7. The vibration damping apparatus according to claim 4, wherein
the tubular vibration-damping devices arranged in parallel on a same side of the attachment member are constituted by components identical with each other,
the tubular vibration-damping devices have different springs on respective circumferences, and
the tubular vibration-damping devices arranged in parallel are attached to the attachment member in circumferential orientations different from each other.

8. The vibration damping apparatus according to claim 4, wherein a combined spring of the tubular vibration-damping devices arranged in parallel on one side of the attachment member and that on another side of the attachment member are equal to each other.

9. The vibration damping apparatus according to claim 4, wherein
the tubular vibration-damping devices arranged in parallel on a same side of the attachment member further include respective axis-perpendicular stoppers each limiting an elastic deformation volume of the corresponding connecting rubber elastic body in an axis-perpendicular direction, and
in the tubular vibration-damping devices, the axis-perpendicular stoppers each limit the elastic deformation volume of the corresponding connecting rubber elastic body in the axis-perpendicular direction different from each other.

10. The vibration damping apparatus according to claim 1, wherein the inner shaft member and the outer tube member are bonded to the connecting rubber elastic body.
